(19) United States
(12) Patent Application Publication
(10) Pub. No.: US 2019/0273934 A1
(43) Pub. Date: Sep. 5, 2019

(54) Method and Apparatus for Inverse Discrete Cosine Transform, And Video Coding/Decoding Method and Framework

(71) Applicant: PEKING UNIVERSITY SHENZHEN GRADUATE SCHOOL, Shenzhen, Guangdong (CN)

(72) Inventors: Ronggang WANG, Shenzhen (CN); Kaili YAO, Shenzhen (CN); Zhenyu WANG, Shenzhen (CN); Wen GAO, Shenzhen (CN)

(73) Assignee: Peking University Shenzhen Graduate School, Shenzhen, Guangdong (CN)

(21) Appl. No.: 16/085,308

(22) PCT Filed: Mar. 17, 2016
(86) PCT No.: PCT/CN2016/076579

§ 371 Date: Sep. 14, 2018

(51) Int. Cl. H04N 19/44; H04N 19/124; H04N 19/18; H04N 19/12

(52) U.S. Cl. CPC H04N 19/45; H04N 19/12; H04N 19/18; H04N 19/124

(57) ABSTRACT

The present disclosure discloses a method and apparatus for fast inverse discrete cosine transform and a video coding/decoding method and framework. By recording positions of non-zero coefficients in a transform unit during a procedure of performing inverse quantization scanning to the coefficients, determining a distribution pattern of non-zero coefficients of the transform unit based on the positions of non-zero coefficients, and further selecting an inverse discrete cosine transform function corresponding to the non-zero coefficient distribution pattern, and then performing inverse cosine transform to the function, the technical solutions of the present disclosure need not compute the zero coefficients, which thus improves the overall speed of an algorithm; because the positions of non-zero coefficients have been recorded during the procedure of performing inverse quantization scanning to the coefficients, the complexity of the algorithm is lowered.

### FIELD

Embodiments of the present disclosure generally relate to the field of video coding/decoding, and more particularly relate to a method and apparatus for inverse discrete cosine transform, and a video coding/decoding method and framework thereof.

### BACKGROUND

Video coding is a technology of removing redundant information from digital video data by using a data compression technology to reduce the data amount needed to represent the original video, for the convenience of transmission and storage. The currently mainstream video compression standards all adopt a block-based predict-transform hybrid framework, which eliminates statistical redundancy in a video by methods of predicting, transforming, and entropy coding, etc.

DCT (Discrete Cosine Transform) is an arithmetical operation closely related to the Fourier transform. In a Fourier series expansion, if the expanded function is a real even function, its Fourier series only includes a cosine term, and a cosine transform may be derived by discretizing the cosine term; therefore, this process is referred to as discrete cosine transform. A corresponding inverse transform is referred to as IDCT (Inverse Discrete Cosine Transform). The DCT/IDCT are always applied in compressing images and videos, which may significantly decorrelate the video images; because signal energy is mainly focused on a few low-frequency coefficients and most of high-frequency coefficient values are zero, the data of video images may be effectively compressed by quantizing and entropy coding. The DCT/IDCT technology is adopted by various video coding and decoding standards such as MPEG-4, H.264, HEVC, AVS2 in a transform/inverse transform module.

In the existing IDCT algorithms, not only the non-zero coefficient points in a transform unit need to be computed, the zero coefficient points are also subjected to redundancy computation, which reduces the overall speed of the algorithms and deteriorates the performance thereof.

### SUMMARY

According to one aspect of the present disclosure, a method for inverse discrete cosine transform is provided, the method being for processing a transform unit of a video frame, comprising:

a position recording procedure: performing inverse quantization scanning to coefficients, and meanwhile recording positions of non-zero coefficients in the transform unit;

a pattern determining procedure: determining a non-zero coefficient distribution pattern of the transform unit based on the positions of non-zero coefficients;

an inverse transform procedure: selecting an inverse discrete cosine transform function corresponding to the non-zero coefficient distribution pattern of the transform unit, and performing inverse discrete cosine transform based on the function.

According to a second aspect of the present disclosure, a method for video coding/decoding is provided, comprising:

a discrete cosine transform procedure: performing discrete cosine transform to a transform unit;

a quantization scanning procedure to coefficients: performing quantization scanning to the transform unit having been subjected to the discrete cosine transform;

a position recording procedure: performing inverse quantization scanning to the coefficients, and meanwhile recording positions of non-zero coefficients in the transform unit;

a pattern determining procedure: determining a non-zero coefficient distribution pattern based on the positions of non-zero coefficients;

an inverse transform procedure: selecting an inverse discrete cosine transform function corresponding to the non-zero coefficient distribution pattern of the transform unit, and performing inverse discrete cosine transform based on the function, wherein the inverse discrete cosine transform function does not perform computation to zero-coefficients.

According to a third aspect of the present disclosure, an apparatus for inverse discrete cosine transform is provided, for processing a transform unit of a video frame, comprising: an inverse quantization module configured for recording positions of non-zero coefficients in the transform unit during a procedure of performing inverse quantization scanning to the coefficients; a determining module configured for determining a non-zero coefficient distribution pattern based on the positions of non-zero coefficients; and an inverse discrete cosine transform module configured for selecting an inverse discrete cosine transform function corresponding to the non-zero coefficient distribution pattern of the transform unit, and performing inverse discrete cosine transform based on the function.

According to a fourth aspect of the present disclosure, a framework for video coding/decoding is provided, comprising: a discrete cosine transform module configured for performing discrete cosine transform to a transform unit; a quantization module connected to the discrete cosine transform module and an inverse quantization module, configured for performing quantization scanning to a transform unit that having been subjected to the discrete cosine transform; the inverse quantization module configured for recording positions of non-zero coefficients in the transform unit during a procedure of performing inverse quantization scanning to the coefficients; a determining module connected to the inverse quantization module, configured for determining a non-zero coefficient distribution pattern based on the positions of non-zero coefficients; and an inverse discrete cosine transform module connected to the determining module, configured for selecting an inverse discrete cosine transform function corresponding to the non-zero coefficient distribution pattern of the transform unit, and performing inverse discrete cosine transform based on the function, wherein the inverse discrete cosine transform function does not perform computation to zero-coefficients.

By recording positions of non-zero coefficients in a transform unit during a procedure of performing inverse quantization scanning to the coefficients, determining a distribution pattern of non-zero coefficients of the transform unit, and further selecting an inverse discrete cosine transform function corresponding to the non-zero coefficient distribution pattern, and then performing inverse cosine transform to the function, the method and apparatus for fast inverse discrete cosine transform and the video coding/decoding method and framework provided by the present disclosure need not compute the zero coefficients, which thus improves the overall speed of an algorithm; because the positions of non-zero coefficients have been recorded during the procedure of performing inverse quantization scanning to the coefficients, the complexity of the algorithm is lowered.

### BRIEF DESCRIPTION OF THE DRAWINGS

FIG. 1 is a structural schematic diagram of an apparatus for fast inverse discrete cosine transform according to an embodiment 1 of the present disclosure;

FIG. 2 is a schematic diagram of a video coding framework according to an embodiment of the present disclosure;

FIG. 3 is a schematic diagram of a video decoding framework according to an embodiment of the present disclosure;

FIG. 4 is a schematic flow diagram of a method for fast inverse discrete cosine transform at a coding end according to an embodiment of the present disclosure;

FIG. 5 is a schematic diagram of a non-zero coefficient distribution pattern of a transform unit according to an embodiment of the present disclosure;

FIG. 6 is a schematic diagram of a principle of inverse discrete cosine transform according to an embodiment of the present disclosure;

FIG. 7 is a schematic diagram of a principle of selection by a determining module according to an embodiment of the present disclosure;

FIG. 8 is a setting diagram of experiment parameters on an AVS2 coder according to an embodiment of the present disclosure; and

FIG. 9 is a schematic diagram of experiment results on an AVS2 coder according to an embodiment of the present disclosure.

### DETAILED DESCRIPTION OF EMBODIMENTS

Hereinafter, the present disclosure will be described in further detail through preferred embodiments with reference to the accompanying drawings.

The present disclosure provides a method and apparatus for fast inverse discrete cosine transform, which are applicable to video coding frameworks and video decoding frameworks of various standards, and a framework and method for video coding/decoding. The present disclosure is applicable to the field of video compression, and more specifically applicable to various video encoders and decoders, which may satisfy an array of video coding/decoding standards such as AVS2, MPEG-4, H.264 and/or HEVC, and may, for example, process transform units of different sizes such as 8×8, 16×16, 32×32, 64×64, 16×4, 32×8, 4×16, and 8×32 in the AVS2 standard. Video coding needs to perform discrete cosine transform and inverse discrete cosine transform to an image, while video decoding only needs to perform inverse discrete cosine transform. The method and apparatus for fast inverse discrete cosine transform, and the video coding/decoding method and framework according to the present disclosure may improve the operation speed and reduce the operation complexity of the video coding/decoding technology during the phase of inverse discrete cosine transform.

### An Embodiment

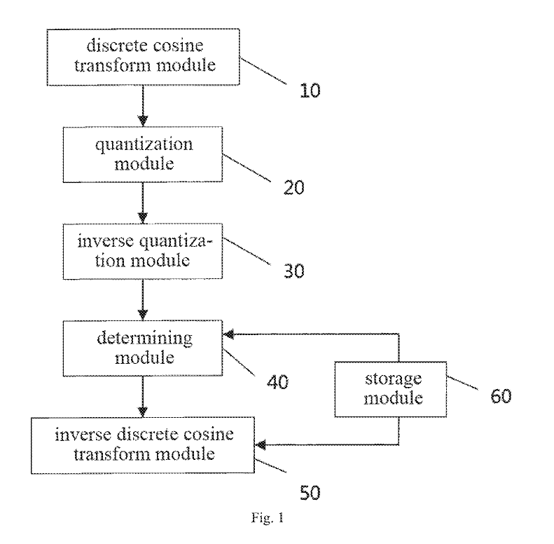

As shown in FIG. 1, the apparatus for fast inverse discrete cosine transform according to this embodiment comprises a discrete cosine transform module 10, a quantization module 20, an inverse quantization module 30, a determining module 40, and an inverse discrete cosine transform module 50, which are sequentially connected, and further comprise a storage module 60 connected to the determining module 40 and the inverse discrete cosine transform module 50.

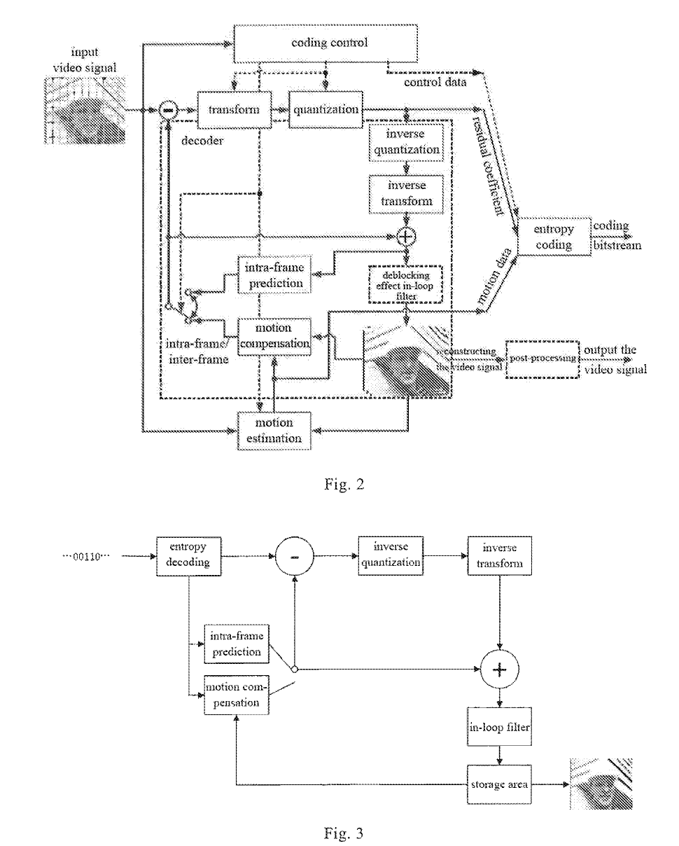

The apparatus for fast inverse discrete cosine transform in this embodiment is part of the video coding/decoding framework of the present disclosure, and the fast inverse discrete cosine transform method in this embodiment is also an intermediary procedure of the video coding/decoding method of the present disclosure. FIG. 2 shows a logic relation of the fast inverse discrete cosine transform process of the present disclosure in a video coding framework; FIG. 3 shows a logic relation of the fast inverse discrete cosine transform process of the present disclosure in a video decoding framework, wherein a basic pattern for the video coding framework and the video decoding framework of the present disclosure adopts a technical solution followed by various standards in the prior art; however, the inverse discrete cosine transform process adopts the method in this embodiment so as to improve the operation speed. The procedures such as coding control, in-frame prediction, motion compensation, motion estimation, entropy coding, and post-processing of the video coding framework in FIG. 2 adopt those technical solutions used by a conventional video coding framework, which are thus not elaborated here; the procedures such as entropy decoding, in-frame prediction, motion compensation, and in-loop filtering in FIG. 3 also adopt the technical solutions of a conventional video decoding framework, which are thus not elaborated here.

In this embodiment, after receiving a certain frame of image, the apparatus for fast inverse discrete cosine transform reduces a certain transform unit of the image into original pixel blocks, wherein the TU may include, for example, 4×4, 8×8, 16×16, 32×32, 64×64, 4×16, 16×4, 8×32, or 32×8 pixel blocks; in the coding control, the image may be divided into a plurality of or various kinds of TUs, and the decoding is mainly done based on the division during the coding procedure. In the coding control, the image may be divided into various kinds of TUs, and the decoding is mainly done based on the division during the coding procedure. In this embodiment, the apparatus for fast inverse discrete cosine transform restores a certain transform unit after DCT to the original pixel block, wherein the TU may include, for example, 4×4, 8×8, 16×16, 32×32, 64×64, 4×16, 16×4, 8×32, or 32×8 pixel blocks.

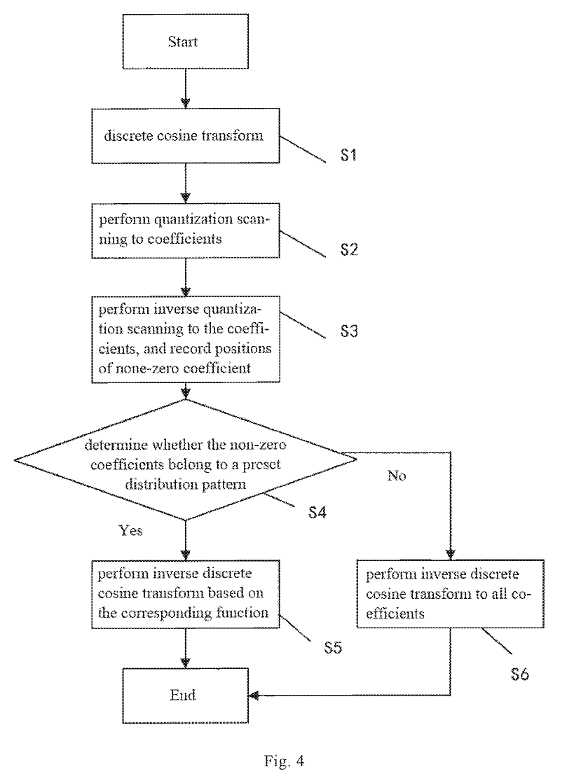

A schematic flow diagram of a method for fast inverse discrete cosine transform at a coding end is shown in FIG. 4, comprising:

S1: a discrete cosine transform procedure: performing, by the discrete cosine transform module 10, discrete cosine transform to a transform unit;

S2: a quantization scanning procedure to coefficients: performing, by the quantization module 20, quantization scanning to the transform unit having been subjected to discrete cosine transform, so as to reduce a data amount needing to be coded/decoded and lower a data representation precision, thereby achieving an objective of data compression. Those skilled in the art should understand that what is processed by the quantization module 20 is not the original image pixels any more, but the transformed coefficients.

S3: a position recording procedure: performing, by the inverse quantization module 30, inverse quantization (IQ) scanning to the transform unit to restore data, and meanwhile recording positions of non-zero coefficients in the transform unit.

Specifically, the inverse quantization module 30 scans all coefficients of the transform unit; if a certain coefficient is a non-zero coefficient, performs inverse quantization processing to the non-zero coefficient, and meanwhile records the position of the non-zero coefficient; while if a certain coefficient is a zero coefficient, does not perform inverse quantization processing to the zero coefficient, and the position of the zero coefficient is not recorded either.

For example, for a certain 16×16 transform unit, the inverse quantization module 30 scans the 256 coefficients of the transform unit, performs inverse quantization processing to the non-zero coefficients and record their positions.

S4: a pattern determining procedure: determining, by the determining module 40, a non-zero coefficient distribution pattern based on the positions of non-zero coefficients.

Specifically, the storage module 60 stores a plurality of non-zero coefficient distribution patterns; for a position distribution characteristic of non-zero coefficients of a certain type of transform unit, the storage module 60 stores a non-zero coefficient distribution pattern corresponding to the position distribution characteristic of the non-zero coefficients of the type.

The following approaches may be adopted for a specific pattern determining procedure: the determining module 40 determines, based on a position of a non-zero coefficient, whether the non-zero coefficient of the transform unit is within a certain preset range, wherein the preset range has a non-zero coefficient distribution pattern corresponding thereto; if the non-zero coefficient of the transform unit is within the certain preset range, determines that the transform unit belongs to the non-zero coefficient distribution pattern corresponding to the preset range, and executes S5; and if the transform unit does not belong to any non-zero coefficient distribution pattern, determines that the transform unit belongs to a general pattern and executes S6. There is a higher probability for a transform unit satisfying a preset range distribution to appear in the preset range.

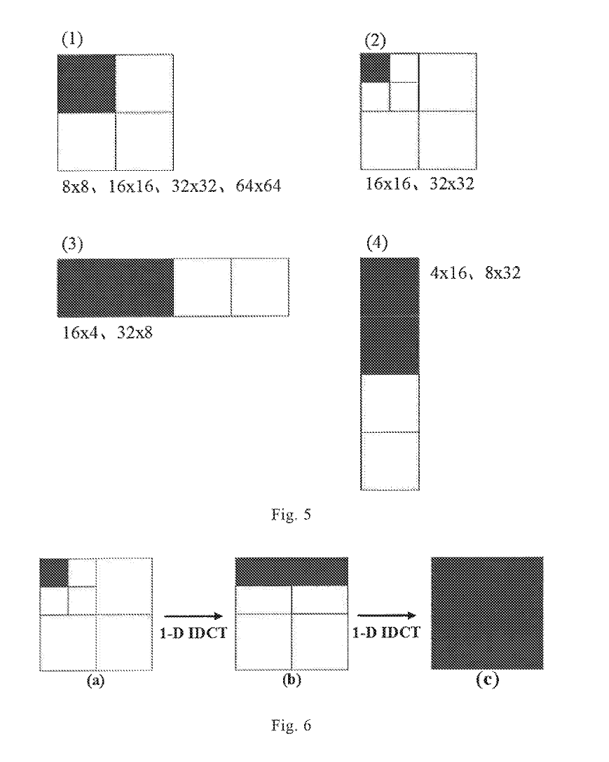

FIG. 5 is a schematic diagram of some applicable TU non-zero coefficient distribution patterns of this embodiment. Specifically, for an 8×8, 16×16, 32×32, or 64×64 transform unit of the AVS2 standard, when the non-zero coefficients are concentrated within the range of one quarter at the left upper corner (the black portion) of the transform unit, the transform unit may be matched to the non-zero coefficient distribution pattern shown in FIG. 5(1), wherein the range of one quarter at the upper left corner of the transform unit is the preset range; for a 16×16 or 32×32 transform unit, when the non-zero coefficients are distributed in the range of one sixteenth at the upper left corner of the transform unit, the transform unit may be matched to the non-zero coefficient distribution pattern shown in FIG. 5(2); for a 16*4 or 32*8 transform unit, when the non-zero coefficients are distributed in a range of the left half part of the transform unit, the transform unit may be matched to the non-zero coefficient distribution pattern shown in FIG. 5(3); and when the non-zero coefficients are distributed in a range of the upper half part of the transform unit, the transform unit may be matched to the non-zero coefficient distribution pattern shown in FIG. 5(4).

If the non-zero coefficients are not distributed in any preset range defined by the determining module 40, the transform unit does not belong to any non-zero coefficient distribution pattern, and then the determining module 40 determines that the transform unit belongs to a general pattern. For example, if the non-zero coefficients are not concentrated in any preset range shown in FIG. 5, but scattered in various areas of the transform unit, then the transform unit belongs to a general pattern. For example, a preset range of a 16×16 transform unit is defined as (x/16)>=8 or (x mod 16)>=8; once it is found that the coordinate (x) of a certain non-zero coefficient position exceeds the preset range, then the transform unit may be determined as the “general pattern.”

S5: an inverse transform procedure: selecting, by the inverse discrete cosine transform module 60, an inverse discrete cosine transform function corresponding to the non-zero coefficient distribution pattern of the transform unit, and performing inverse discrete cosine transform based on the function.

Specifically, each non-zero coefficient distribution pattern corresponds to one inverse discrete cosine transform function and is stored in a storage module 60, and the inverse discrete cosine transform function only performs inverse discrete cosine transform operation only to the non-zero coefficients in the transform unit, without computing the non-zero coefficients.

For example, a certain 64*64 transform unit corresponds to the non-zero coefficient distribution pattern shown in FIG. 5(1); then, the inverse discrete cosine transform module 50 selects the inverse discrete cosine transform function corresponding to the non-zero coefficient distribution pattern shown in FIG. 5(1), and performs inverse discrete cosine transform operation to the non-zero coefficients within the range of one quarter at the upper left of the transform unit using the function. If a certain 4*16 transform unit corresponds to the non-zero coefficient distribution pattern shown in FIG. 5(4), the inverse discrete cosine transform module 50 selects the inverse discrete cosine transform function corresponding to the non-zero coefficient distribution pattern shown in FIG. 5(4), and performs inverse discrete cosine transform operation to the non-zero coefficients within the range at the upper half of the transform unit using the function.

To facilitate understanding, a principle of selecting, by the inverse discrete cosine transform module 50, the corresponding inverse discrete cosine transform function and performing transform to the function will be briefly explained. As illustrated in FIG. 6, the inverse discrete cosine transform module 50 selects a non-zero coefficient distribution pattern corresponding to a certain transform unit shown in FIG. 5(2), i.e., the non-zero coefficient distribution pattern shown in FIG. 6(a). In the inverse discrete cosine transform operation, the first operation, i.e., the operation procedure from FIG. 6(a) to FIG. 6(b), may save 15/16 of the originally needed computation amount, and the second operation, i.e., the operation procedure from FIG. 6(b) to FIG. 6(c), may save ¾ of the computation amount, such that the whole process may save a computation amount of 84.375%. Likewise, it may be derived that the computation amounts that may be correspondingly saved by the inverse discrete cosine transforms of FIG. 5(1)˜FIG. 5(4) are 62.5%, 84.375%, 25%, and 25%, respectively.

For the S5 procedure, if more than one non-zero coefficient distribution patterns are optional for one transform unit, the inverse discrete cosine transform module 50 determines the non-zero coefficient distribution pattern with the highest priority as the non-zero coefficient distribution pattern for the current transform unit. In this embodiment, it may be specifically defined that a non-zero coefficient distribution pattern with a higher operation efficiency has a higher priority.

With the 16×16 transform unit shown in FIG. 7 as an example, the gray portion represents the actual non-zero coefficient distribution in the unit. It may be seen from FIG. 5 that there are two non-zero coefficient distribution patterns corresponding to the 16×16 transform unit, i.e., FIG. 5(1) and FIG. 5(2); besides, there is further an optional general pattern that does not make fast transform. Because it has been predefined that the non-zero coefficient distribution pattern shown in FIG. 5(1) has a higher priority, the inverse discrete cosine transform module 50 selects the non-zero coefficient distribution pattern of FIG. 5(1) to correspond to the transform unit, and performs an inverse discrete cosine transform operation corresponding to the non-zero coefficient distribution pattern of FIG. 5(1).

S6: because the transform unit does not have a corresponding non-zero coefficient distribution pattern, i.e., the transform unit belongs to a general pattern, the inverse discrete cosine transform module 50 performs the original inverse discrete cosine transformation to the entire transform unit.

For a circumstance where the transform unit corresponds to a certain non-zero coefficient distribution pattern in FIG. 5, the inverse discrete cosine transform module 50 performs inverse discrete cosine transform operation only on the non-zero coefficients within a preset range, while an area outside of the preset range needs no operation, which reduces the computation amount and the steps needed to be executed by an operation program, thereby facilitating the overall speed of the algorithm. For a transform unit corresponding to a general pattern, because the range for the inverse discrete cosine transform module 50 to perform the original inverse discrete cosine transform is the entire transform unit, i.e., traversing the entire transform unit and performing the inverse discrete cosine transform operation to the non-zero coefficients, there is no reduction of the computational amount and no speed-up.

Those skilled in the art should understand that the decoding end does not need the discrete cosine transform procedure or the quantization scanning procedure to coefficient; therefore, compared with FIG. 4, the method flow of the fast inverse discrete cosine transform at the decoding end does not include the procedures of S1 and S2, but the other procedures are consistent to those at the coding end, which are thus not elaborated here.

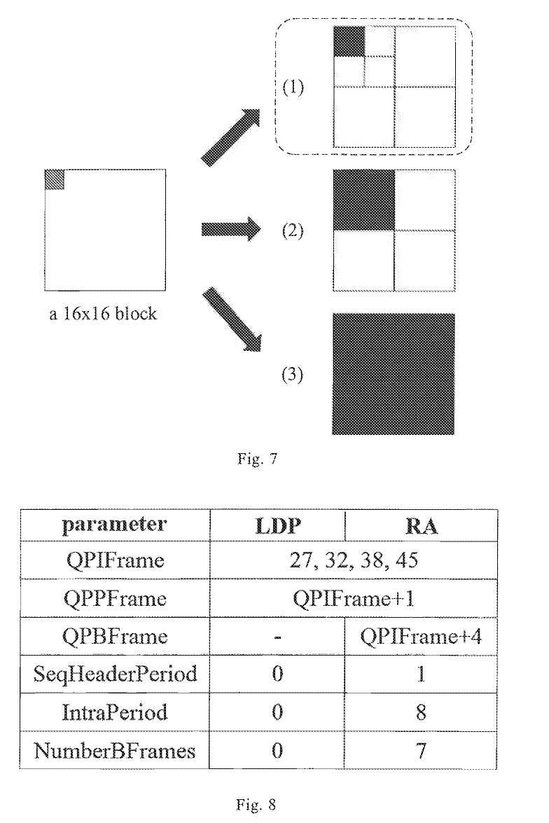

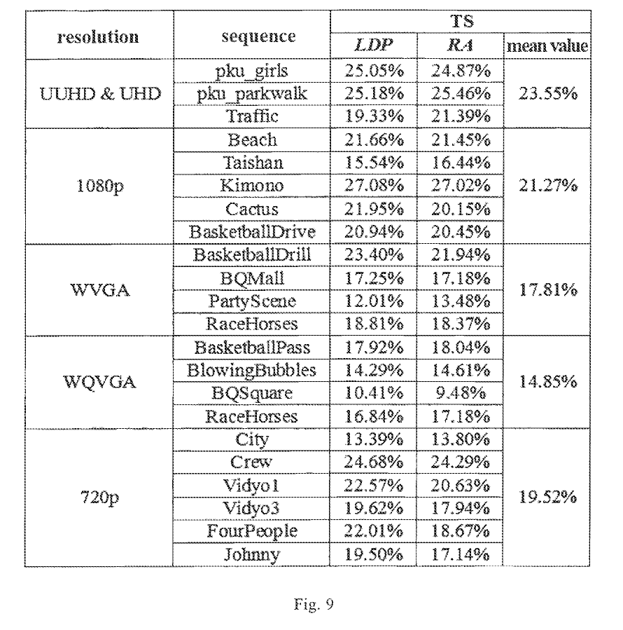

Based on the parameter configurations in FIG. 8, the experiment results of this embodiment on the AVS2 RD12.0 coding platform are shown in FIG. 9. Because the present disclosure involves two modules (i.e., IDCT and IQ) during the coding/decoding process, the speeds are compared based on the total time of the IDCT module and the total time of the IQ module; the TS in FIG. 9 is defined as a mean ratio of the time saved under the 4 test QPs over the originally consumed time. The experiment shows that the present disclosure may significantly improve the speed of the IDCT module, wherein the speeds are improved by 19.52% and 19.09% under LDP and RA configurations, respectively.

By recording positions of non-zero coefficients in a transform unit during a procedure of performing inverse quantization scanning to the coefficients, determining a distribution pattern of non-zero coefficients of the transform unit, and further selecting an inverse discrete cosine transform function corresponding to the non-zero coefficient distribution pattern, and then performing inverse cosine transform to the function, the method and apparatus for fast inverse discrete cosine transform provided by the present disclosure has the following advantages: because it is not needed to compute the zero coefficients, the operation speed of the inverse discrete cosine transform module in the coder/decoder is improved, such that the overall speed and performance is significantly improved based on the method and apparatus; corresponding non-zero coefficient distribution patterns and inverse discrete cosine transform functions are designed for all transform units of different sizes in the AVS2, such that various kinds of transform units can be processed well; because the positions of the non-zero coefficients are recorded during the procedure of performing inverse quantization scanning to the coefficients, without a need of an additional procedure of recording the positions of the non-zero coefficients, the algorithm complexity is lowered; because the present disclosure omits the IDCT operations on the zero coefficients to guarantee the operations on the non-zero coefficients (i.e., valid coefficients), no quality loss will be incurred in respect of effect; and the method and apparatus for fast inverse discrete cosine transform provided by the present disclosure are all applicable in the coder and decoder, which thus have a wide application prospect.

What have been illustrated above are further detailed explanations with reference to the preferred embodiments, and it should not be construed that the preferred embodiments are only limited to those explanations. For a person of normal skill in the art, various simple derivations or substitutions may also be made without departing from the idea of the present disclosure.

I/We claim:

1. A method for inverse discrete cosine transform, the method being for processing a transform unit of a video frame, comprising:
a position recording procedure: performing inverse quantization scanning to coefficients, and meanwhile recording positions of non-zero coefficients in the transform unit;
a pattern determining procedure: determining a non-zero coefficient distribution pattern of the transform unit based on the positions of non-zero coefficients; and
an inverse transform procedure: selecting an inverse discrete cosine transform function corresponding to the non-zero coefficient distribution pattern of the transform unit, and performing inverse discrete cosine transform based on the function.

2. The method according to claim 1, wherein:
the pattern determining procedure specifically comprises:
determining whether non-zero coefficients of the transform unit are located within a certain preset range based on the positions of non-zero coefficients, wherein the preset range has a corresponding non-zero coefficient distribution pattern;
if the non-zero coefficients of the transform unit are located within a certain preset range, determining that the transform unit belongs to the non-zero coefficient distribution pattern corresponding to the preset range; and
if the transform unit does not belong to any non-zero coefficient distribution pattern, determining that the transform unit belongs to a general pattern.

3. A video coding/decoding method, comprising:
a discrete cosine transform procedure: performing discrete cosine transform to a transform unit;
a quantization scanning procedure to coefficients: performing quantization scanning to the transform unit having been subjected to the discrete cosine transform;
a position recording procedure: performing inverse quantization scanning to the coefficients, and meanwhile recording positions of non-zero coefficients in the transform unit;
a pattern determining procedure: determining a non-zero coefficient distribution pattern based on the positions of non-zero coefficients;
an inverse transform procedure: selecting an inverse discrete cosine transform function corresponding to the non-zero coefficient distribution pattern of the transform unit, and performing inverse discrete cosine transform based on the function, wherein the inverse discrete cosine transform function does not perform computation to zero-coefficients.

4. The method according to claim 3, wherein:
the pattern determining procedure specifically comprises:
determining whether non-zero coefficients of the transform unit are located within a certain preset range based on the positions of non-zero coefficients, wherein the preset range has a corresponding non-zero coefficient distribution pattern;
if the non-zero coefficients of the transform unit are located within a certain preset range, determining that the transform unit belongs to the non-zero coefficient distribution pattern corresponding to the preset range; and
if the transform unit does not belong to any non-zero coefficient distribution pattern, determining that the transform unit belongs to a general pattern.

5. The method according to claim 3 or 4, wherein:
the video coding/decoding standard in the method is AVS2, MPEG-4, H.264 or HEVC.

6. An apparatus for inverse discrete cosine transform, the apparatus being for processing a transform unit of a video frame, comprising:
an inverse quantization module configured for recording positions of non-zero coefficients in the transform unit during a procedure of performing inverse quantization scanning to the coefficients;
a determining module connected to the inverse quantization module, configured for determining a non-zero coefficient distribution pattern based on the positions of non-zero coefficients; and
an inverse discrete cosine transform module connected to the determining module, configured for selecting an inverse discrete cosine transform function corresponding to the non-zero coefficient distribution pattern of the transform unit, and performing inverse discrete cosine transform based on the function, wherein the inverse discrete cosine transform function does not perform computation to zero-coefficients.

7. The apparatus according to claim 6, wherein:
the determining module is specifically configured for determining whether non-zero coefficients of the transform unit are located within a certain preset range based on the positions of non-zero coefficients, wherein the preset range has a corresponding non-zero coefficient distribution pattern;
if the non-zero coefficients of the transform unit are located within a certain preset range, determining that the transform unit belongs to the non-zero coefficient distribution pattern corresponding to the preset range; and
if the transform unit does not belong to any non-zero coefficient distribution pattern, determining that the transform unit belongs to a general pattern.

8. A video coding/decoding framework, comprising:
a discrete cosine transform module configured for performing discrete cosine transform to a transform unit;
a quantization module connected to the discrete cosine transform module and an inverse quantization module, configured for performing quantization scanning to a transform unit that having been subjected to the discrete cosine transform;
the inverse quantization module configured for recording positions of non-zero coefficients in the transform unit during a procedure of performing inverse quantization scanning to the coefficients;
a determining module connected to the inverse quantization module, configured for determining a non-zero coefficient distribution pattern based on the positions of non-zero coefficients; and
an inverse discrete cosine transform module connected to the determining module, configured for selecting an inverse discrete cosine transform function corresponding to the non-zero coefficient distribution pattern of the transform unit, and performing inverse discrete cosine transform based on the function, wherein the inverse discrete cosine transform function does not perform computation to zero-coefficients.

9. The framework according to claim 8, wherein:
the determining module is specifically configured for determining whether non-zero coefficients of the transform unit are located within a certain preset range based on the positions of non-zero coefficients, wherein the preset range has a corresponding non-zero coefficient distribution pattern;
if the non-zero coefficients of the transform unit are located within a certain preset range, determining that the transform unit belongs to the non-zero coefficient distribution pattern corresponding to the preset range; and
if the transform unit does not belong to any non-zero coefficient distribution pattern, determining that the transform unit belongs to a general pattern.

10. The framework according to claim 8 or 9, wherein:
a video coding/decoding standard for the framework is AVS2, MPEG-4, H.264 or HEVC.
